(19) United States
(12) Patent Application Publication
(10) Pub. No.: US 2007/0035890 A1
(43) Pub. Date: Feb. 15, 2007

(54) Composed free layer for stabilizing magnetoresistive head having low magnetostriction

(75) Inventor: Rachid Sbiaa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: TDK CORPORATION, Tokyo (JP)

(21) Appl. No.: 10/572,070

(22) PCT Filed: Apr. 2, 2004
(86) PCT No.: PCT/JP04/04828

§ 371 Date: Mar. 15, 2006

(51) Int. Cl. G11B 5/33; G11B 5/127

(52) U.S. Cl. 360/324.11; 360/324.12

(57) ABSTRACT

A magnetoresistive read head includes a spin valve having at least one free layer spaced apart from at least one pinned layer by a spacer. The free layer includes a thin CoFeOx lamination layer in the CoFe, and an optional Cu layer. The amount of oxygen is below 10% of total gas. The pinned layer is a single layer, or a synthetic multi-layered structure having a spacer between sub-layers, and may have the foregoing low-magnetostriction material. As a result, low magnetostriction is obtained to improve read quality and/or improve the pinned field of the pinned layer. Other parameters are not adversely affected.

### TECHNICAL FIELD

The present invention relates to the field of a read element of a magnetoresistive (MR) head. More specifically, the present invention relates to a spin valve of an MR read element with a free layer having a low magnetostriction material.

### Background Art

In the related art magnetic recording technology such as hard disk drives, a head is equipped with a reader and a writer. The reader and writer have separate functions and operate independently of one another, with no interaction therebetween.

FIGS. 1(a) and (b) illustrate related art magnetic recording schemes. A recording medium 1 having a plurality of bits 3 and a track width 5 has a magnetization parallel to the plane of the recording media. As a result, a magnetic flux is generated at the boundaries between the bits 3. This is commonly referred to as “longitudinal magnetic recording”.

Information is written to the recording medium 1 by an inductive write element 9, and data is read from the recording medium 1 by a read element 11. A write current 17 is supplied to the inductive write element 9, and a read current is supplied to the read element 11.

The read element 11 is a sensor that operates by sensing the resistance change as the sensor magnetization direction changes from one direction to the other. A shield 13 reduces the undesirable magnetic fields coming from the media and prevents the undesired flux of adjacent bits from interfering with the one of the bits 3 that is currently being read by the read element 11.

In the foregoing related art scheme, the area density of the recording medium 1 has increased substantially over the past few years, and is expected to continue to increase substantially over the next few years. Correspondingly, the bit density and track density are expected to increase. As a result, the related art reader must be able to read this data having increased density at a higher efficiency and speed.

Due to these requirements, another related art magnetic recording scheme has been developed, as shown in FIG. 1(b). In this related art scheme, the direction of magnetization 19 of the recording medium 1 is perpendicular to the plane of the recording medium. This is also known as “perpendicular magnetic recording”. This design provides more compact and stable recorded data.

FIGS. 2(a)-(c) illustrate various related art read elements for the above-described magnetic recording scheme, known as “spin valves”. In the bottom type spin valve illustrated in FIG. 2(a), a free layer 21 operates as a sensor to read the recorded data from the recording medium 1. A spacer 23 is positioned between the free layer 21 and a pinned layer 25. On the other side of the pinned layer 25, there is an anti-ferromagnetic (AFM) layer 27.

In the top type spin valve illustrated in FIG. 2(b), the position of the layers is reversed. The operation of the related art spin valves illustrated in FIGS. 2(a)-(b) is substantially similar, and is described in greater detail below.

The direction of magnetization in the pinned layer 25 is fixed, whereas the direction of magnetization in the free layer 21 can be changed, for example (but not by way of limitation) depending on the effect of an external field, such as the recording medium 1.

When the external field (flux) is applied to a reader, the magnetization of the free layer 21 is altered, or rotated, by an angle. When the flux is positive the magnetization of the free layer is rotated upward, and when the flux is negative the magnetization of the free layer is rotated downward. Further, if the applied external field changes the free layer 21 magnetization direction to be aligned in the same way as pinned layer 25, then the resistance between the layers is low, and electrons can more easily migrate between those layers 21, 25.

However, when the free layer 21 has a magnetization direction opposite to that of the pinned layer 25, the resistance between the layers is high. This high resistance occurs because it is more difficult for electrons to migrate between the layers 21, 25.

Similar to the external field, the AFM layer 27 provides an exchange coupling and keeps the magnetization of pinned layer 25 fixed. The properties of the AFM layer 27 are due to the nature of the materials therein. In the related art, the AFM layer 27 is usually PtMn or IrMn.

The resistance change when the layers 21, 25 are parallel and anti-parallel AR should be high to have a highly sensitive reader. As head size decreases, the sensitivity of the reader becomes increasingly important, especially when the magnitude of the media flux is decreased. Thus, there is a need for a high resistance change ΔR between the layers 21, 25 of the related art spin valve.

FIG. 2(c) illustrates a related art dual type spin valve. Layers 21 through 25 are substantially the same as described above with respect to FIGS. 2(a)-(b). However, an additional spacer 29 is provided on the other side of the free layer 21, upon which a second pinned layer 31 and a second AFM layer 33 are positioned. The dual type spin valve operates according to the same principle as described above with respect to FIGS. 2(a)-(b). However, an extra signal provided by the second pinned layer 31 increases the resistance change ΔR.

FIG. 6 graphically shows the foregoing principle in the case of the related art longitudinal magnetic recording scheme as illustrated in FIG. 1(a). As the sensor moves across the recording media, the flux of the recording media at the boundary between bits, as shielded with respect to adjacent bits, provides the flux to the free layer, which acts according to the related art spin valve principles.

The operation of the related art spin valve is now described in greater detail. In the recording media 1, flux is generated based on polarity of adjacent bits. If two adjoining bits have negative polarity at their boundary the flux will be negative. On the other hand, if both of the bits have positive polarity at the boundary the flux will be positive. The magnitude of flux determines the angle of magnetization between the free layer and the pinned layer.

In addition to the foregoing related art spin valve in which the pinned layer is a single layer, FIG. 3 illustrates a related art synthetic spin valve. The free layer 21, the spacer 23 and the AFM layer 27 are substantially the same as described above. In FIG. 3 only one state of the free layer is illustrated. However, the pinned layer further includes a first sublayer 35 separated from a second sublayer 37 by a spacer 39.

In the related art synthetic spin valve, the first sublayer 35 operates according to the above-described principle with respect to the pinned layer 25. Additionally, the second sublayer 37 has an opposite spin state with respect to the first sublayer 35. As a result, the pinned layer total moment is reduced due to anti-ferromagnetic coupling between the first sublayer 35 and the second sublayer 37. A synthetic spin valve head has a pinned layer with a total magnetic flux close to zero and thus greater stability and high pinning field can be achieved than with the single layer pinned layer structure.

FIG. 4 illustrates the related art synthetic spin valve with a shielding structure. As noted above, it is important to avoid unintended magnetic flux from adjacent bits from being sensed during the reading of a given bit. A protective layer 41 is provided on an upper surface of the free layer 21 to protect the spin valve against oxidation before deposition of top shield 43, by electroplating in separated system. Similarly, a bottom shield 45 is provided on a lower surface of the AFM layer 27. A buffer layer, not shown in FIG. 4, is usually deposited before AFM layer 27 for a good spin-valve growth. The effect of the shield system is shown in FIG. 6, as discussed above.

As shown in FIGS. 5(a)-(d), there are four related art types of spin valves. The type of spin valve structurally varies based on the structure of the spacer 23.

The related art spin valve illustrated in FIG. 5(a) uses the spacer 23 as a conductor, and is used for the related art CIP scheme illustrated in FIG. 1(a) for a giant magnetoresistance (GMR) type spin valve. The direction of sensing current magnetization, as represented by “i”, is in the plane of the GMR element.

In the related art GMR spin valve, resistance is minimized when the magnetization directions (or spin states) of the free layer 21 and the pinned layer 25 are parallel and is maximized when the magnetization directions are opposite. As noted above, the free layer 21 has a magnetization of which the direction can be changed. Thus, the GMR system avoids perturbation of the head output signal by minimizing the undesired switching of the pinned layer magnetization.

GMR depends on the degree of spin polarization of the pinned and free layers, and the angle between their magnetic moments. Spin polarization depends on the difference between the spin state (up or down) in each of the free and pinned layers.

The GMR scheme will now be discussed in greater detail. As the free layer 21 receives the flux that signifies bit transition, the free layer magnetization rotates by a small angle in one direction or the other, depending on the direction of flux. The change in resistance between the pinned layer 25 and the free layer 21 is proportional to angle between the moments of the free layer 21 and the pinned layer 25. There is a relationship between resistance change and efficiency of the reader.

The GMR spin valve has various requirements. For example, but not by way of limitation, a large resistance change ΔR is required to generate a high output signal. Further, low coercivity is desired, so that small media fields can also be detected. With high pinning field strength, the AFM structure is well defined. When the interlayer coupling is low the sensing layer is not adversely affected by the pinned layer. Further, low magnetistriction is desired to minimize stress on the free layer.

However, the foregoing related art CIP-GMR has various disadvantages. One of them is that the electrode connected to the free layer must be reduced in size that will cause overheating and damage to the head. Also, the readout signal available from CIP-GMR is proportional to the MR head width. As a result, there is a limitation for CIP-GMR at high recording density.

As a result, related art magnetic recording schemes use a CPP-GMR head, where the sensing current flows perpendicular to the spin valve plane. In CPP mode, the signal increases as the sensor width is reduced. Various related art spin valves that operate in the CPP scheme are illustrated in FIGS. 5(b)-(d), and are discussed in greater detail below.

FIG. 5(b) illustrates a related art tunneling magnetoresistive (TMR) spin valve for CPP scheme. In the TMR spin valve, the spacer 23 acts as an insulator, or tunnel barrier layer. Thus, the electrons can cross the insulating spacer 23 from free layer to pinned layer or verse versa. TMR spin valves have an increased MR on the order of about 30-50%.

FIG. 5(c) illustrates a related art CPP-GMR spin valve. While the general concept of GMR is similar to that described above with respect to CIP-GMR, the current is transferred perpendicular to the plane, instead of in-plane. As a result, the difference in resistance and the intrinsic MR are substantially higher than the CIP-GMR.

In the related art CPP-GMR spin valve, there is a need for a large resistance change ΔR, and a moderate element resistance for having a high frequency response. A low coercivity is also required so that a small media field can be detected. The pinning field should also have a high strength. Additional details of the CPP-GMR spin valve are discussed in greater detail below.

FIG. 5(d) illustrates the related art ballistic magnetoresistance (BMR) spin valve. In the spacer 23, which operates as an insulator, a ferromagnetic region 47 connects the pinned layer 25 to the free layer 21. The area of contact is on the order of a few nanometers. As a result, there is a substantially high MR, due to electrons scattering at the magnetic domain wall created within this nanocontact. Other factors include the spin polarization of the ferromagnets, and the structure of the domain that is in nano-contact with the BMR spin valve.

However, the related art BMR spin valve is in early development. Further, there are related art issues with the BMR spin valve in that nano-contact shape and size controllability and stability of the domain wall must be further developed. Additionally, the repeatability of the BMR technology is yet to be shown for high reliability.

In the foregoing related art spin valves of FIGS. 5 (a)-(d), the spacer 23 of the spin valve is an insulator for TMR, a conductor for GMR, and an insulator having a magnetic nano-sized connector for BMR. While related art TMR spacers are generally made of insulating metals such as alumina, related art GMR spacers are generally made of conductive metals, such as copper.

FIGS. 7(a)-(b) illustrate the structural difference between the CIP and CPP GMR spin valves. As shown in FIG. 7(a), there is a hard bias 998 on the sides of the GMR spin valve, with an electrode 999 on upper surfaces of the GMR. Gaps 997 are also required. As shown in FIG. 7(b), in the CPP-GMR spin valve, an insulator 1000 is deposited at the side of the spin valve that the sensing current can only flow in the film thickness direction. Further, no gap is needed in the CPP-GMR spin valve.

As a result, the current has a much larger surface through which to flow, and the shield also serves as an electrode. Hence, the overheating issue is substantially addressed.

Further, the spin polarization of the layers of the spin valve is intrinsically related to the electronic structure of the material, and a relatively high resistive material can induce an increase in the resistance change ΔR. Accordingly, there is an unmet need for a material having the necessary properties and thickness for operation in a CPP-GMR system.

Additional factors associated with the performance of the related art CPP-GMR system are provided below. Various related art studies have demonstrated the effect of electron spin polarized on magnetization switching, including M. Tsoi et al., Phys. Review Letters, 80, 4281 (1998), J. C. Slonczewski, J. Magnetism and Magnetic Materials, 195, L261 (1999), J. A. Katine et al., Phys. Review Letters, 84, 3149 (2000),M. R. Pufall et al., Applied Physics Letters, 83(2), 323 (2003), the contents of which are incorporated herein by reference.

In the related art studies, correlation between intrinsic properties and spin transfer switching has been determined. Also, dynamic response of magnetization switching has been studied. In conclusion, the ability of the head (sensor) to engage in fast switching of magnetization at a high frequency (e.g., GigaHertz) is important for high-speed reading of the recorded information (high data rate).

As recording media bit size is reduced, a thinner free layer is also needed. In the related art, there is currently a need for a free layer with a thickness of less than 3 nm for a sensor having a recording density of about 150 GB per square inch. In the future, it is believed that the need to reduce free layer thickness will continue. There is also a need to sense increasingly smaller bits at a very high frequency (i.e., high data rate) in recording head reader technology.

Magnetostriction (λₛ) is a small variation in the size or shape of a ferromagnetic material that occurs, usually in the free and/or pinned layer, when an external magnetic field is applied. Magnetostriction leads to increases in the anisotropy field. Because the ferromagnetic material of the free layer is crystalline, the external field exerts an increased stress, and as a result, the lattice opens up.

FIGS. 8(a)-(b) shows the change in magnetic structure due to magnetostriction. The domain structure is a representation of demagnetized state. As shown in FIG. 8(a), when there is no external field, there is no change is size or shape. However, when an external field is applied as shown in FIG. 8(b), there is a variation in the size and/or shape of the ferromagnetic material.

Generally, the free layer has magnetic anisotropy, and the easy axis is well defined. However, when the free layer has a high magnetostriction, then due to increased stress caused by the external field, a dispersion of the easy axis occurs. This dispersion changes the easy axis, which results in noise during the process of reading the recording media. Thus, read quality is reduced.

Similarly, magnetostriction can affect the pinned layer. A high magnetostriction can cause instability according to the above-described principles, and can result in the pinned layer having a reduced pinned field.

In the related art magnetic head and magnetic memory based on magnetoresistive effect, the free layer has a coercivity lower than 20 Oe, high spin polarization, low anisotropy and low magnetostriction. Additionally, properties related to stability, stiffness and exchange coupling with the pinned layer must be considered.

Permalloy Ni₈₀Fe₂₀ (Py) has been widely used for spintronic devices due to its softness, low magnetostriction and relatively large spin polarization. As related art magnetoresistive heads use the above-described related art spin valve structure, the free layer is completely or at least partially made of Py.

Due to the continuous need for high spin polarization materials capable of increasing the magnetoresistance ratio (MR), CoFe has been found to be more effective than Py for the free layer. However, the related art CoFe free layer has a disadvantage in that the magnetostriction λₛ is high. As a result the structure of the ferromagnetic material is distorted.

Aspin-valve with only CoFe has a better MR than composed free layer of NiFe/CoFe, which has a better MR than a free layer with only NiFe. The related art NiFe free layer has various problems, including low spin polarization and low ΔR.

The best related art CoFe composition to date is Co₉₀Fe₁₀ due to its low coercivity field Hc as compared with Py, which also has a high MR. While Co₉₀Fe₁₀ itself has a relatively low magnetostriction compared to other iron rich CoFe alloys, in the related art spin-valve structure, the deposition of Co_{90 Fe}₁₀ on a non magnetic spacer such as Cu forces the lattice constant of Co₉₀Fe₁₀ to deviate from its bulk value. Further, the magnetostriction of CoFe is still too high to meet the related art magnetoresistive head requirements.

Accordingly, there is a need to have a low, positive magnetostriction λₛ to avoid the related art problems of reduced output, increased noise, and/or reduced pinning field strength.

Magnetoresistance is a function of the applied magnetic field. FIG. 9 shows this relationship for a related art synthetic spin-valve. Hₚᵢₙ is the exchange-coupling field between the AFM layer and the pinned layer. It is defined as the field in which a half MR ratio is measured.

As shown in FIG. 10, for small-applied fields (low field measurement) the interlayer-coupling field represented by Hᵢₙₜₑᵣ is the field between pinned and free layers. The weak interlayer coupling is required for head and MRAM application, because the free layer will be under an external field and a stabilizer.

Thus, there are related art requirements for magnetoresistive heads, including (but not limited to) low coercivity, moderate resistance and low magnetostriction, to reduce the stress effect on the free layer when an external magnetic field is applied.

There are various problems and disadvantages in the related art. For example, but not by way of limitation, the related art problem of noise associated with a high magnetostriction is described above. As a result of the foregoing related art problems, the signal to noise ratio is reduced.

Accordingly, there is a related art need to minimize the related art problems caused by high magnetostriction, such that the free layer magnetization is affected only by the media flux.

### DISCLOSURE OF INVENTION

It is an object of the present invention to overcome at least the aforementioned problems and disadvantages of the related art. However, it is not necessary for the present invention to overcome those problems and disadvantages, nor any problems and disadvantages.

To achieve at least this object and other objects, a magnetic sensor is provided for reading a recording medium and having a spin valve. The magnetic sensor includes a free layer having an magnetization adjustable in response to an external field, a pinned layer having a fixed magnetization; a spacer sandwiched between the pinned layer and the free layer, and an antiferromagnetic (AFM) layer positioned on a surface of the pinned layer opposite the spacer. The AFM layer fixes pinned layer magnetization, and at least one of the free layer and the pinned layer comprises a first CoFeOₓ layer sandwiched between a first CoFe layer and a second CoFe layer.

### BRIEF DESCRIPTION OF DRAWINGS

The above and other objects and advantages of the present invention will become more apparent by describing in detail preferred exemplary embodiments thereof with reference to the accompanying drawings, wherein like reference numerals designate like or corresponding parts throughout the several views, and wherein:

FIGS. 1(a) and (b) illustrates a related art magnetic recording scheme having in-plane and perpendicular-to-plane magnetization, respectively;

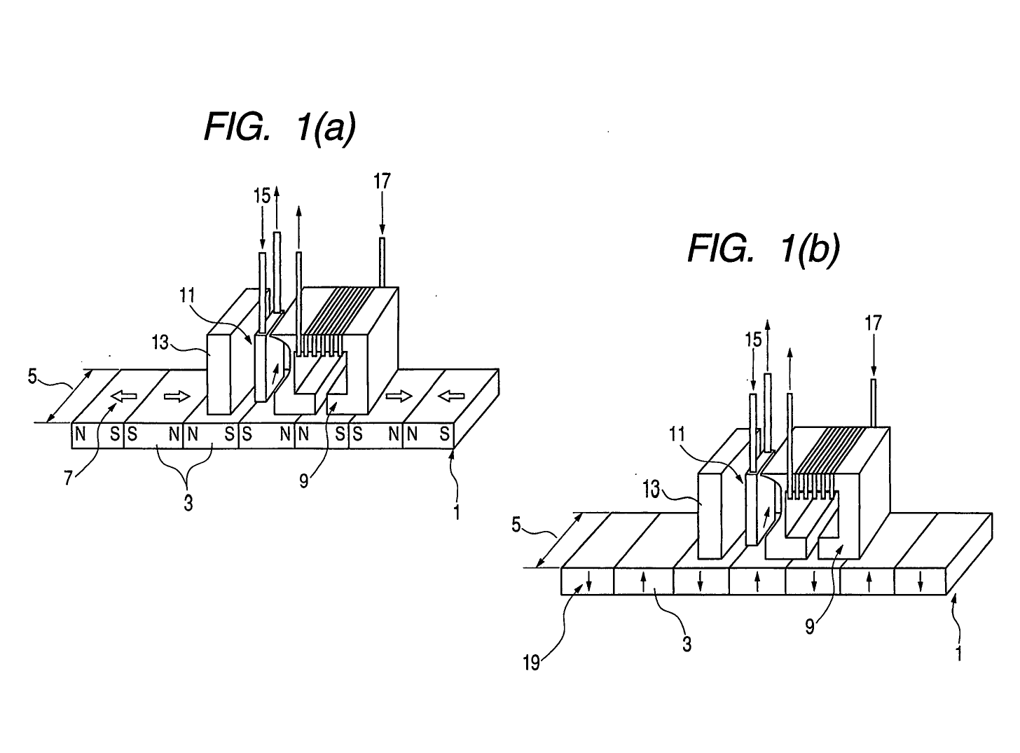

FIGS. 2(a)-(c) illustrate related art bottom, top and dual type spin valves;

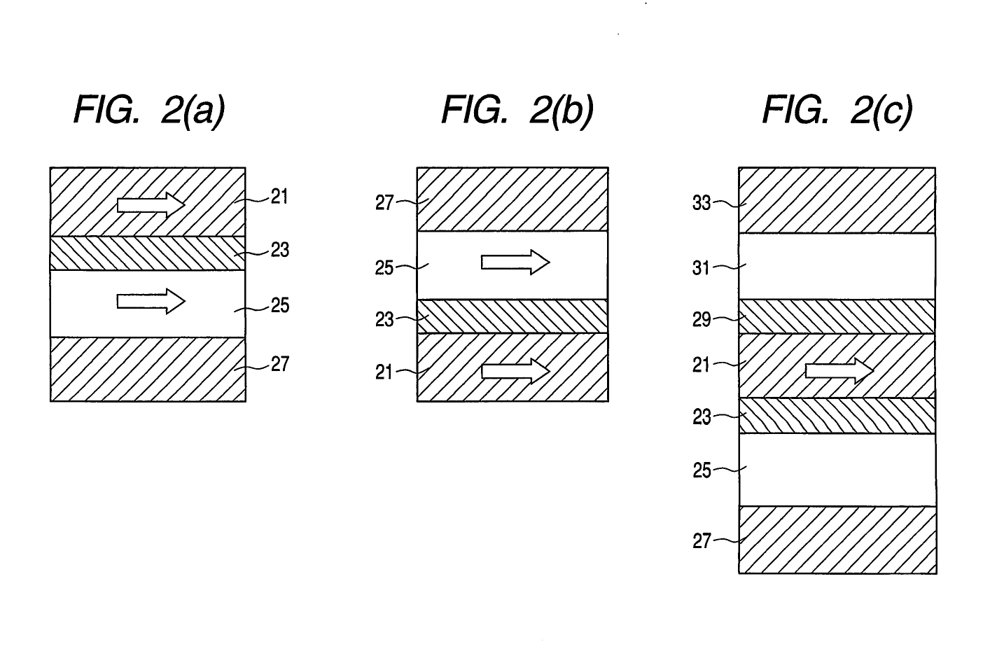

FIG. 3 illustrates a related art synthetic spin valve;

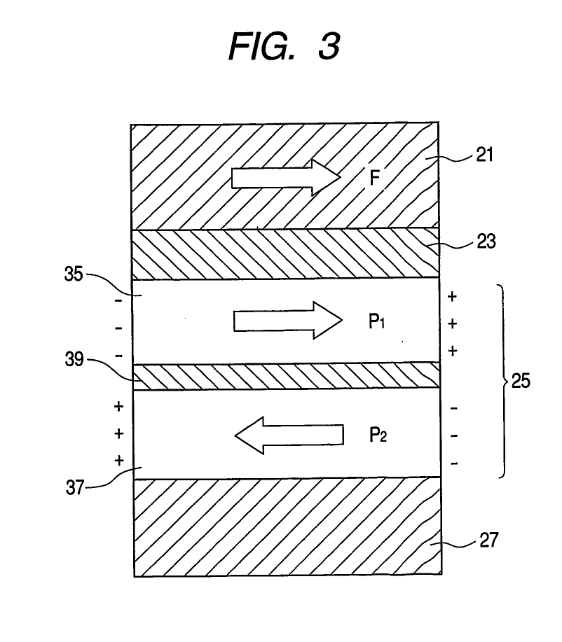

FIG. 4 illustrates a related art synthetic spin valve having a shielding structure;

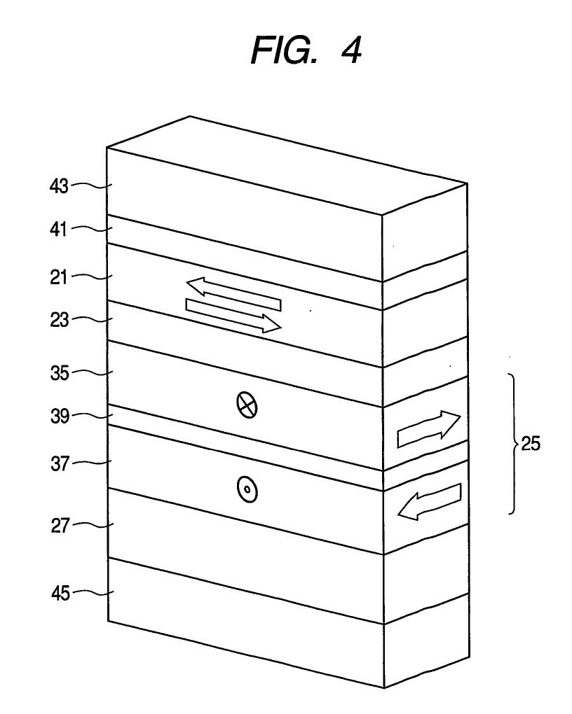

FIGS. 5(a)-(d) illustrates various related art magnetic reader spin valve systems;

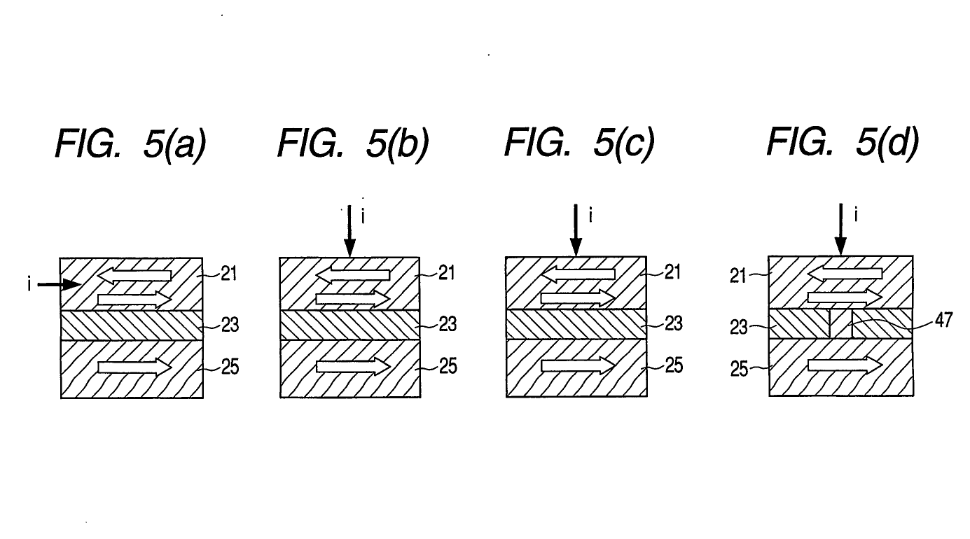

FIG. 6 illustrates the operation of a related art GMR sensor system;

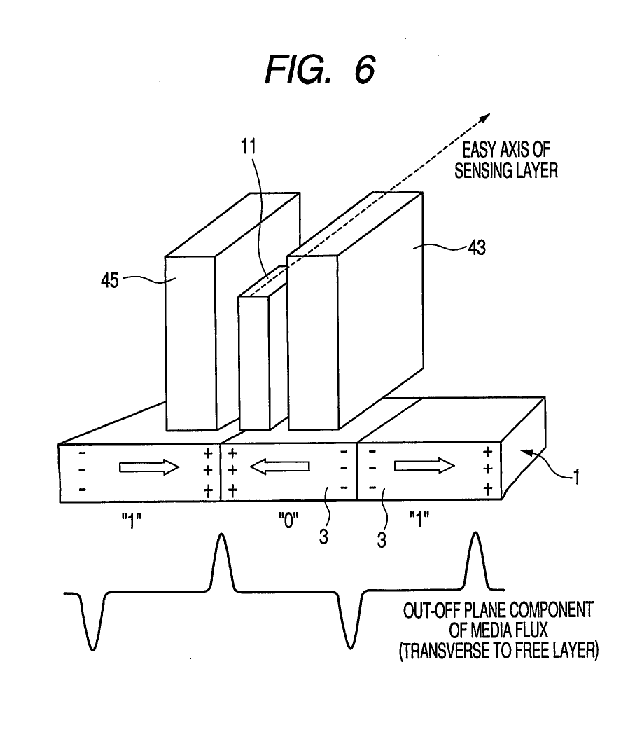

FIGS. 7(a)-(b) illustrate related art CIP and CPP GMR systems, respectively;

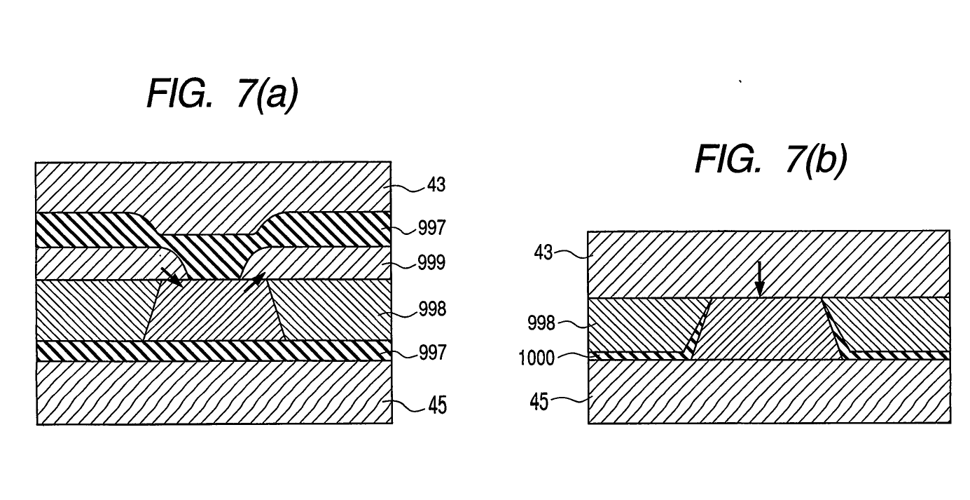

FIGS. 8(a)-(b) illustrate the related art principle of magnetostriction as applied to a related art ferromagnetic layer;

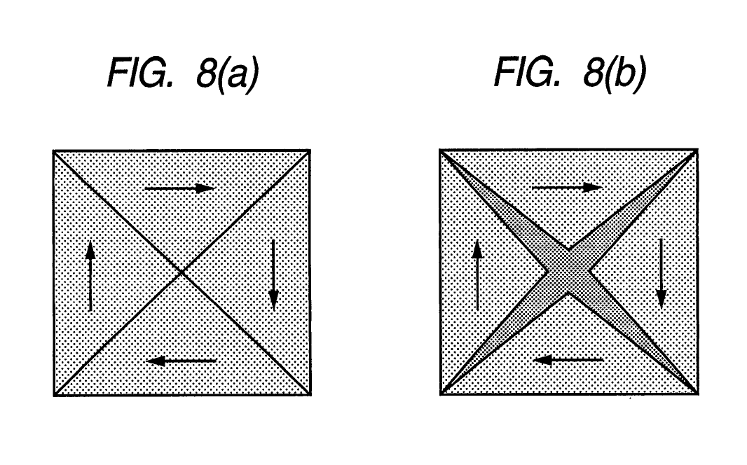

FIG. 9 illustrates the derivation of Hₚᵢₙ;

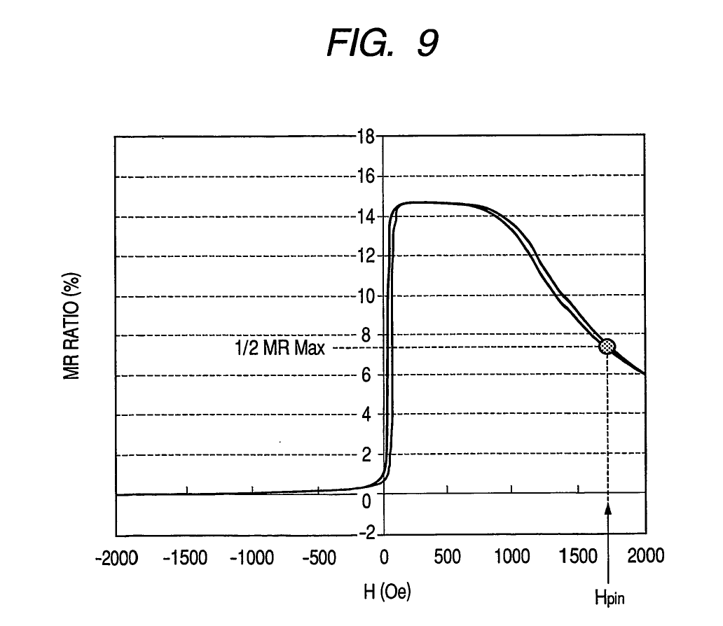

FIG. 10 illustrates the derivation of Hᵢₙₜₑᵣ;

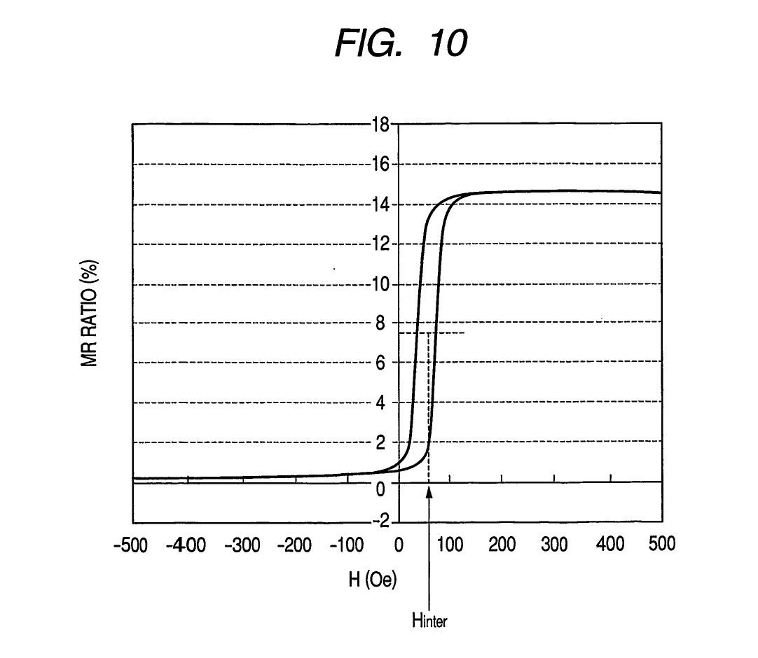

FIG. 11 illustrates an exemplary, non-limiting embodiment of the present invention;

FIG. 12 illustrates another exemplary, non-limiting embodiment of the present invention;

FIG. 13 illustrates yet another exemplary, non-limiting embodiment of the present invention;

FIG. 14 illustrates still another exemplary, non-limiting embodiment of the present invention;

FIG. 15 illustrates results of experimentation on the performance of the free layer according to an exemplary, non-limiting embodiment of the present invention as compared with the related art;

FIG. 16 illustrates results of experimentation on the performance of the free layer according to another exemplary, non-limiting embodiment of the present invention as compared with the related art; and

FIG. 17 illustrates binding energy of still another exemplary, non-limiting embodiment of the present invention as compared with the related art.

### MODES FOR CARRYING OUT THE INVENTION

Referring now to the accompanying drawings, description will be given of preferred embodiments of the invention.

In an exemplary, non-limiting embodiment of the present invention, a novel spin valve for a magnetoresistive head having a free layer material with low, positive magnetostriction is provided, resulting in an improved spin valve.

More specifically, Co₉₀Fe₁₀ alloys are used in the free layer without NiFe lamination or Ni substitution. Further, a thin CoFeOx layer less than 2 angstroms in thickness is included for adjusting the magnetostriction in a very small magnitude while not substantially changing other magnetic properties, such as (but not limited to) resistance, coercivity and MR ratio.

A wide range of magnetostriction values is obtained by modifying the oxygen concentration and/or the thickness of CoFeOx lamination. The magnetostriction is switched from negative values of the related art structure to positive values.

The foregoing scheme can also be used in the pinned layer, because a pinned layer with CoFe has the same magnetostriction and stability issues as the free layer. For example, but not by way of limitation, the related art magnetostriction problem in the pinned layer is a reduction of the pinning field (i.e., exchange coupling with AFM layer).

In another exemplary, non-limiting embodiment of the present invention, a thin Co₉₀Fe₁₀Ox layer with a laminated free layer of (Co₉₀Fe₁₀/Cu) has a Cu layer thickness below 5 angstroms. This scheme is appropriate for the related art CPP-spin valves. The increased number of interfaces contributes to the increased resistance change ΔR between parallel and antiparallel magnetic configuration.

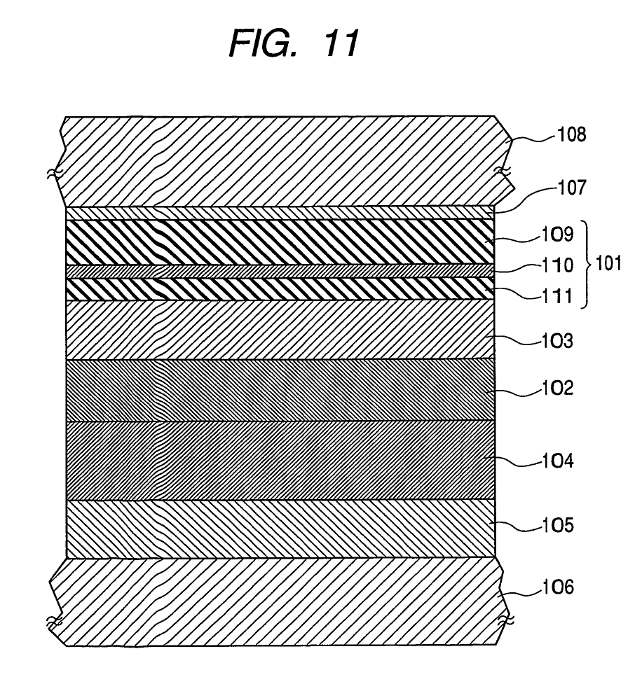

FIG. 11 illustrates an exemplary, non-limiting embodiment of the present invention. A spin valve is provided, having a free layer 101 separated from a pinned layer 102 by a non-magnetic spacer 103. Further, an anti-ferromagnetic (AFM) layer 104 is located on the other side of the pinned layer 102, and a buffer 105 is positioned below the AFM layer 104. The buffer layer 105 provides desired growing conditions for the layers deposited thereon.

A capping layer 107, preferably made of copper (Cu) metal, is positioned above the free layer 101. Further, a bottom lead 106 and a top lead 108 are provided for flow of the sensing current.

The free layer 101 includes a first CoFe layer 109 below the capping layer 107, at least one CoFeOx lamination layer 110 below the first CoFe layer 109, and a second CoFe layer 111 below the lamination CoFeOx layer 110. The first and second CoFe layers 109, 111 are preferably made of Co₉₀Fe₁₀, and the CoFeOx lamination layer 110 is preferable made of Co₉₀Fe₁₀ as well. However, the foregoing proportions are approximate in nature, and materials having substantially similar or equivalent proportions of Co and Fe may be used instead or in combination with the foregoing proportions. In the present invention x can equal 1 or 2 wherever CoFeOx is used, and represents the oxidation of the oxygen molecule. Here, the values of 1 and 2 for x respectively refer to 2 and 4% oxygen included with argon gas during CoFeOx deposition.

While the current in the exemplary, non-limiting embodiment illustrated in FIG. 11 flows in the direction of film thickness as the CPP scheme, this configuration may also be used for the CIP scheme. Any modifications to the overall head required for using the CIP scheme are believed to be well-known in the related art.

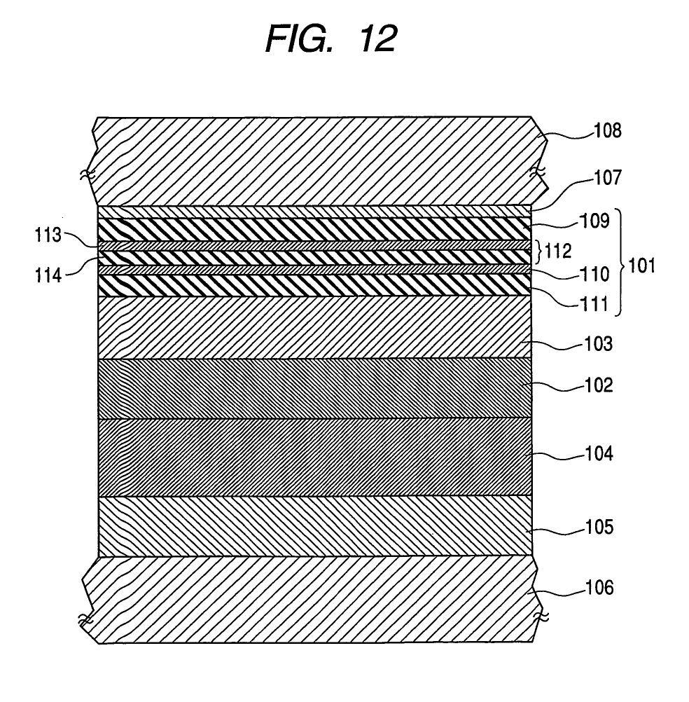

FIG. 12 illustrates another exemplary, non-limiting embodiment of the present invention. Descriptions of those portions of FIG. 12 that are substantially the same as described above with respect to FIG. 11 are not repeated.

In the free layer 101, in addition to the first CoFe layer 109 and the CoFeOx lamination layer 110 on the second CoFe layer 111, a multilayer structure 112 is provided. This multi-layer structure includes (but is not limited to) another CoFeOx Lamination layer 113 positioned below the first CoFe layer 109, and another CoFe layer 114 positioned below the CoFeOx lamination layer 113. Similar to the foregoing first embodiment, Co and Fe are provided in a proportion of about Co₉₀Fe₁₀.

While only a single multilayer 112 is shown in FIG. 12, additional multilayers may also be used. Further, either of the foregoing embodiments in FIGS. 11 and 12 may also be used in the pinned layer 102 as well as in the free layer 101. As a result of such an application to the pinned layer 102, magnetostriction would be reduced and exchange coupling between AFM layer 104 and pinned layer 102 would be improved,

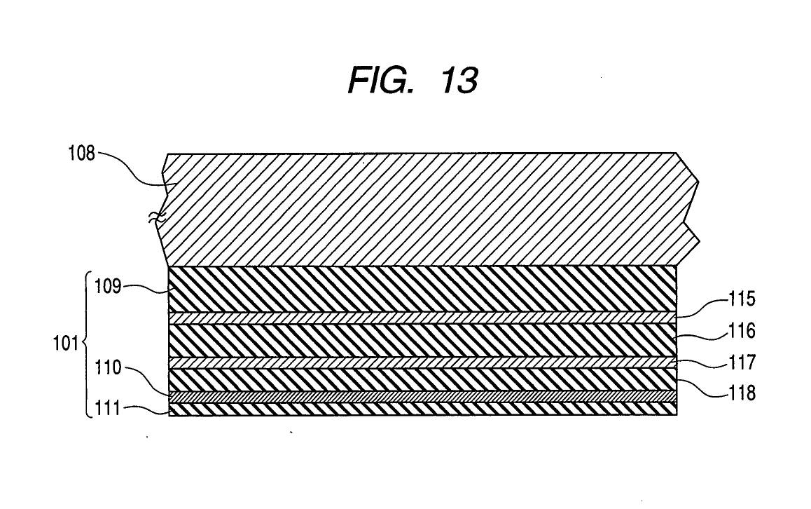

Yet another exemplary, non-limiting embodiment of the present invention is illustrated in FIG. 13. The top lead 108 is the same as described above. However, a capping layer is not provided. Instead, the free layer 101 includes the above-described first CoFe layer 109 below the top lead layer 108, as well as the second CoFe layer 111 above the spacer 103 and the CoFeOx lamination layer 110 above the second CoFe layer 111.

Additionally, a first thin Cu lamination layer 115 is positioned between the first CoFe layer 109 and a third CoFe layer 116, and a second thin Cu lamination layer 117 is positioned between the third CoFe layer 116 and a fourth CoFe layer 118, which is positioned on the CoFeOx layer 110. Similar to the foregoing embodiments, the proportion CoFe in these layers is about Co₉₀Fe₁₀.

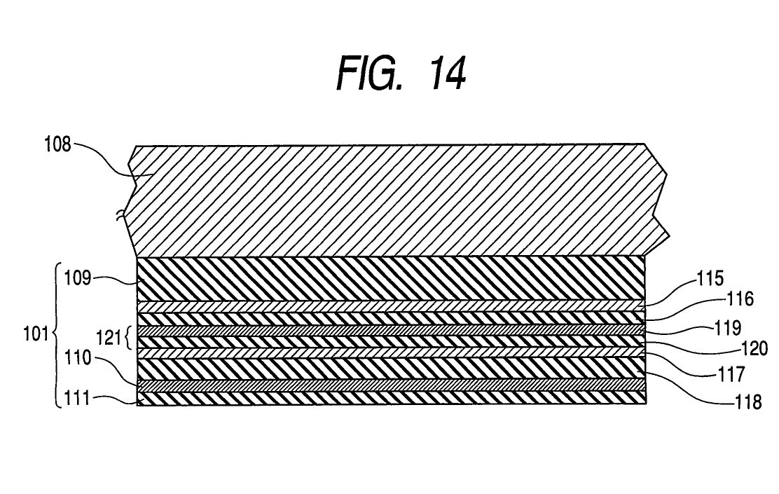

FIG. 14 illustrates still another exemplary, non-limiting embodiment of the present invention. The part of the invention substantially the same as described above with respect to FIG. 13 is not repeated here.

In the free layer 101, a multilayer structure 121 is provided. This multilayer structure includes (but is not limited to) another CoFeOx lamination layer 119 positioned below the third CoFe layer 116, and a fifth CoFe layer 120 positioned below the another CoFeOx lamination layer 119, thus above the second thin Cu layer 118. Similar to the foregoing first embodiment, Co and Fe are provided in a proportion of about Co₉₀Fe₁₀.

While only a single multilayer 121 is shown in FIG. 14, additional multilayers may also be used. Further, either of the foregoing embodiments in FIGS. 13 and 14 may be used in the pinned layer 102 as well as in the free layer 101. As a result of such an application to the pinned layer 102, magnetostriction would be reduced and exchange coupling between AFM layer 104 and pinned layer 102 would be improved,

In all of the foregoing embodiments, in the various CoFeOx oxidation layers that have been provided, the percent of oxidation is less about 10 percent with respect to argon gas provided therein. Further, the thickness of the laminated CoFeOx layers in all cases is less than about 5 Å, and can be made from Co₁₋ₓFeₓ, where x=100, 50, 30, 20 and 10%, with a 20% margin in the composition.

Various experimental results showing performance of the present invention in various embodiments is discussed below in greater detail.

Table 1 shows a comparison between various spin valve structures in samples A-D. Sample A is the related art spin valve structure, including the Co₉₀Fe₁₀ free layer. Samples B and D represent an embodiment substantially similar to that of FIG. 11 and sample C represents an embodiment substantially similar to FIG. 12. In samples B and C, the amount of oxygen is about 2% of the total gas pressure.

While the free layer 101 is varied in terms of its thickness and the thickness of the sublayers, the other layers of the spin valve are substantially the same as the related art. Layer thickness is shown in angstroms.

TABLE 1

| | Buffer | AFM | Synthetic Pinned layer | Spacer | Free layer | Cap |
|---|---|---|---|---|---|---|
| Sample A | NiCr | IrMn | CoFe/Ru/CoFe | Cu | CoFe | NiCr |
| | 50 | 70 | 30/8/30 | 32 | 30 | 50 |
| Sample B | NiCr | IrMn | CoFe/Ru/CoFe | Cu | CoFe/CoFeO₁/CoFe | NiCr |
| | 50 | 70 | 3/0.8/3 | 32 | 9/2/20 | 50 |
| Sample C | NiCr | IrMn | CoFe/Ru/CoFe | Cu | CoFe/CoFeO₁/CoFe/CoFeO₁/CoFe | NiCr |
| | 50 | 70 | 30/8/30 | 32 | 9/2/9/2/9 | 50 |
| Sample D | NiCr | IrMn | CoFe/Ru/CoFe | Cu | CoFe/CoFeO₁/CoFe | NiCr |
| | 50 | 70 | 30/8/30 | 32 | 20/2/9 | 50 |

buffer, AFM and pinned layers are the same in all embodiments. The amount of oxygen is about 2% of the total gas these samples.

TABLE 2

| | | | | | Hᵢₙₜₑᵣ | H_{C} | H_{Pin} |
|---|---|---|---|---|---|---|---|
| | λₛ | R (Ω) | ΔR (Ω) | MR (%) | (Oe) | (Oe) | (Oe) |
| Sample A | −9.5E−06 | 2.25 | 0.249 | 11.07 | 17 | 12 | 1550 |
| Sample B | 5.1E−06 | 2.32 | 0.264 | 11.37 | 22 | 19 | 1580 |
| Sample C | 8.6E−06 | 2.32 | 0.265 | 11.42 | 22 | 22 | 1540 |
| Sample D | 6.3E−07 | 2.33 | 0.267 | 11.45 | 18 | 15 | 1570 |

Table 2 shows the performance of the various free layers in terms of intrinsic properties. The related art free layer in sample A has a high, negative magnetostriction, which is not desired. All of samples B-D have positive magnetostriction values. However, sample D has the lowest positive magnetostriction value. There is a strong dependence of magnetostriction on the inserted CoFeOx layer within the free layer. By optimizing the thickness of the CoFe layers 109, 111 and the CoFeOx lamination layer 110, the magnetostriction can be minimized.

The position of lamination is an important parameter. As can be seen, sample D has a magnetostriction of 6.3×10⁻⁷ and its magnetic properties are almost similar to sample A. The only difference between samples B and D is the position of the CoFeOx inside the free layer. Thus, samples B-D achieve a superior magnetostriction without substantially affecting other parameters.

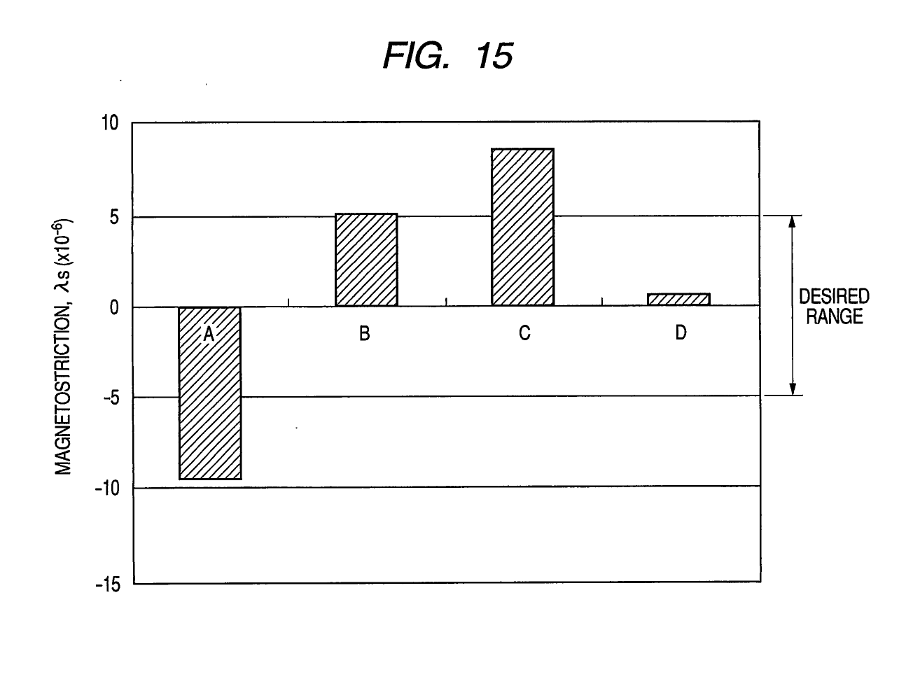

FIG. 15 further illustrates this relationship. The free layer structure having a single CoFeOx structure in samples B and D appears to be for these spin-valve structure effective to reduce the magnetostriction.

Based on the foregoing, the addition of the CoFeOx oxidation layer is understood to change the crystal growth of the free layer. Further, the relative thickness of the layers and the ratio of oxygen in the oxidation layer are important in optimizing magnetic properties.

In the exemplary, non-limiting embodiment of the present invention illustrated in FIGS. 13 and 14, a free layer is laminated with CoFe/Cu. As shown in Table 3, experiments were performed on a laminated free layer of (CoFe/Cu) as in the related art in sample E, and a thin CoFeOx layer was inserted therein as in various embodiments of the present invention in samples F-H.

Samples F and H use the single layer structure while sample G uses a multilayer structure. However, sample F has a CoFeO₁ layer and sample H has a CoFeO₂ layer on the side closest to the spacer. Thus, the main difference between samples F and H is the higher oxidation ratio in sample H. As in Table 1, CoFe generally refers to Co₉₀Fe₁₀. However, the present invention is not limited thereto.

TABLE 3

| | Buffer | AFM | Pinned layers | Spacer | Free layer | Cap |
|---|---|---|---|---|---|---|
| Sample E | NiCr | IrMn | CoFe/Ru/CoFe | Cu | CoFe/Cu/CoFe/Cu/CoFe | NiCr |
| | 50 | 70 | 30/8/30 | 32 | 10/2/10/2/10 | 50 |
| Sample F | NiCr | IrMn | CoFe/Ru/CoFe | Cu | CoFe/CoFeO₁/CoFe/Cu/CoFe | NiCr |
| | 50 | 70 | 30/8/30 | 32 | 9/2/9/2/10 | 50 |
| Sample G | NiCr | IrMn | CoFe/Ru/CoFe | Cu | CoFe/CoFeO₁/CoFe/Cu/CoFe/Cu/CoFe | NiCr |
| | 50 | 70 | 30/8/30 | 32 | 5/2/5/2/10/2/10 | 50 |
| Sample H | NiCr | IrMn | CoFe/Ru/CoFe | Cu | CoFe/CoFeO₂/CoFe/Cu/CoFe | NiCr |
| | 50 | 70 | 30/8/30 | 32 | 9/1/9/2/10 | 50 |

Table 4 shows the performance of samples E-H, the structure of which is shown and described above with respect to Table 3. The performance is described in terms of intrinsic properties.

TABLE 4

| | | | | MR | | H_{C} | Hₚᵢₙ |
|---|---|---|---|---|---|---|---|
| | λₛ | R (Ω) | ΔR (Ω) | (%) | Hᵢₙₜₑᵣ (Oe) | (Oe) | (Oe) |
| Sample E | −9.8E−06 | 2.26 | 0.235 | 10.39 | 19 | 29 | 1540 |
| Sample F | 5.4E−07 | 2.24 | 0.254 | 11.37 | 15 | 26 | 1570 |
| Sample G | −9.3E−07 | 2.30 | 0.237 | 10.29 | 15 | 25 | 1600 |
| Sample H | 4.1E−06 | 2.35 | 0.257 | 10.91 | 18 | 24 | 1570 |

Only one insertion of CoFeOx reduces the magnetostriction from about −1×10⁻⁵ (reference sample E) to about 5×10⁻⁷ (sample F). Thus, the magnetostriction is lower and positive wth respect to the related art of sample E. The other magnetic properties are substantially unchanged.

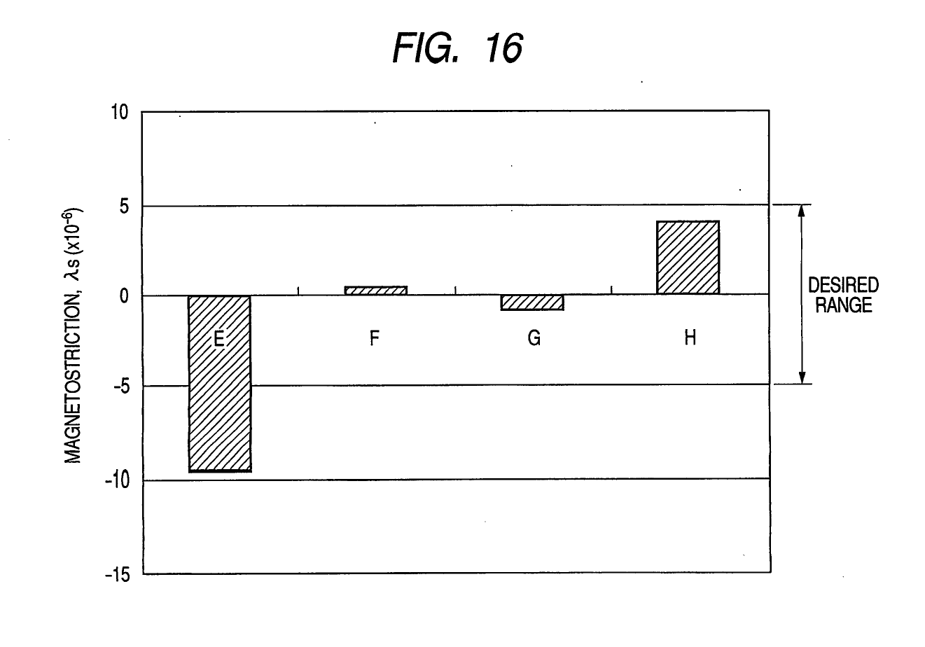

Sample H shows a reduced H_{c} and even slightly better MR ratio and Hpin. However, λₛ is strongly dependent on the lamination of CoFe with CoFeOx, and is substantially higher in sample H than in sample F. FIG. 16 graphically illustrates magnetostriction dependence on the free layer structure for samples E-H shown in Tables 3-4.

For the various embodiments of the present invention, a magnetostriction less than about 5×10⁻⁶ is provided. Depending on the thickness and arrangement of the layers, the magnetostriction can be less than about 10⁻⁷.

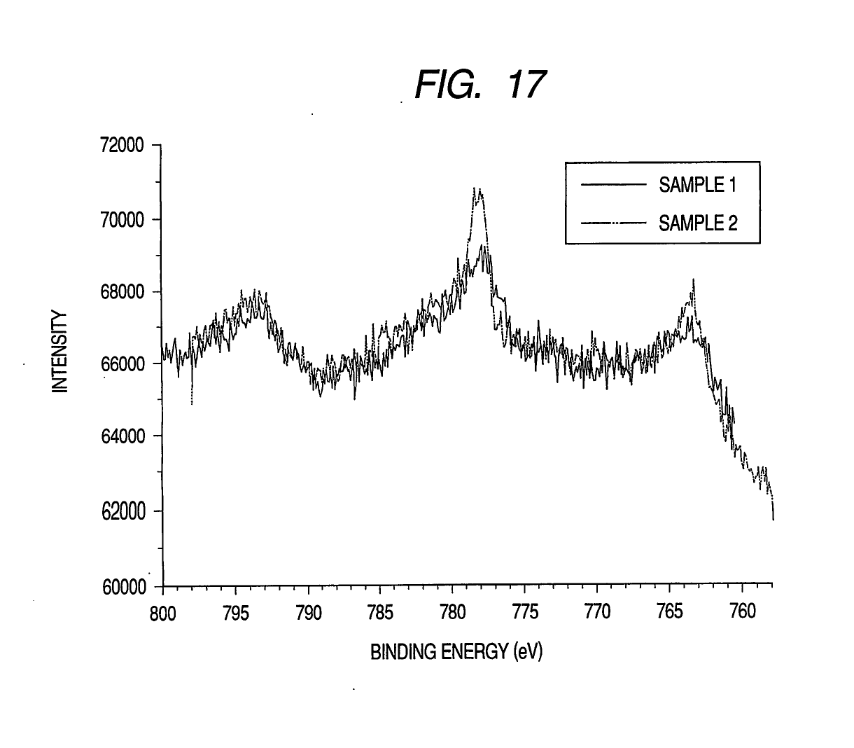

FIG. 17 illustrates the difference between free layer with CoFe only (related art, about 3 nm thick) and CoFe and CoFeOx in terms of the binding energy spectra. These film structures are shown below in Table 5. The results in FIG. 17 can be explained by a break of the Cu effect on the CoFe growth deposited above it. Specifically, when CoFe is directly deposited on Cu spacer, there is deviation of CoFe lattice parameter due to Cu. This thin CoFeOx layer may break or reduce this dependence between Cu and CoFe.

TABLE 5

| | Buffer | Spacer | Free layer | Cap |
|---|---|---|---|---|
| Sample 1 | NiCr 5 | Cu 3 | CoFe 3 | NiCr |
| | | | | 1.5 |
| Sample 2 | NiCr 5 | Cu 3 | CoFe/CoFeO1/CoFe/CoFeO1/CoFe | NiCr |
| | | | 1/0.2/1/0.2/1 | 1.5 |

As shown in FIG. 17, the XPS spectra of the sample 1 and 2 are quite different at 782 eV, which corresponds to the binding energy of Co. The structure of CoFe appears to have been changed by including a CoFeOx layer.

For all of the foregoing exemplary, non-limiting embodiments of the present invention, additional variations may also be provided. For example, but not by way of limitation, the pinned layer 102 may either be synthetic or a single layer as described with respect to the related art.

Also, while FIGS. 11-14 illustrate a bottom type spin valve, the present invention is not limited thereto, and additional embodiments maybe substituted therefor. For example, but not by way of limitation, the foregoing structure may also be a top or dual type spin valve, as would be understood by one skilled in the art.

Further, the spacer 103 is conductive when the spin valve is used in GMR applications, such as CPP- and CIP-GMR spin valves. For TMR applications, the spacer 103 is an insulator. When a connecting is provided as discussed above with respect to the related art, a BMR-type head may be provided. Also the spacer may contain a mixture of conductive and non conductive materials.

Additionally, a stabilizing scheme may be provided, having an insulator and one of an in-stack and hard bias on the top and/or the sides of the sensor.

Further, any of the well-known compositions of those layers other than the free layer 101 and pinned layer 102 and their various exemplary, non-limiting exemplary embodiments, may be used, including (but not limited to) those discussed above with respect to the related art. For example, but not by way of limitation, a synthetic pinned layer or a single-layered pinned layer may be used. Because the compositions of those other layers is well-known to those skilled in the art, it is not repeated here in the detailed description of this invention, for the sake of brevity.

The present invention has various advantages. For example, but not by way of limitation, a low and positive magnetostriction is achieved, while the other properties of the sensor are not substantially affected. As a result, the signal to noise ratio is improved due to reduced noise. When the foregoing structure is applied to the pinned layer as well, the strength of the pinning field is substantially improved.

The present invention is not limited to the specific above-described embodiments. It is contemplated that numerous modifications may be made to the present invention without departing from the spirit and scope of the invention as defined in the following claims.

### INDUSTRIAL APPLICABILITY

The present invention has various industrial applications. For example, it may be used in data storage devices having a magnetic recording medium, such as hard disk drives of computing devices, multimedia systems, portable communication devices, and the related peripherals. However, the present invention is not limited to these uses, and any other use as may be contemplated by one skilled in the art may also be used.

1. A magnetic sensor for reading a recording medium and having a spin valve, comprising:
a free layer having an magnetization direction adjustable in response to an external field;
a pinned layer having a fixed magnetization;
a spacer sandwiched between said pinned layer and said free layer; and
an antiferromagnetic (AFM) layer positioned on a surface of said pinned layer opposite said spacer, that stabilizes said fixed magnetization, wherein at least one of said free layer and said pinned layer comprises a first CoFeOₓ layer sandwiched between a first CoFe layer and a second CoFe layer.

2. The magnetic sensor of claim 1, wherein said X of said first CoFeOx layer is the amount of oxygen therein corresponding and is below 10% with respect to a mixture of said oxygen and argon gas used in oxidation of the first CoFeOx layer.

3. The magnetic sensor of claim 1, wherein said first CoFeOₓ layer has a thickness of less than about 2 angstroms.

4. The magnetic sensor of claim 1, wherein a thickness of said first CoFe layer facing said spacer is optimized relative to a thickness of said second CoFe layer so that said magnetic sensor has a positive magnetostriction less than about 5×10⁻⁶, said thickness of said first CoFe layer is about 20 angstroms and said thickness of said second CoFe layer is about 9 angstroms.

5. The magnetic sensor of claim 1, further comprising:
a capping layer sandwiched between said first CoFe layer of said free layer and a top lead; and
a buffer sandwiched between said AFM layer and a bottom lead, wherein a sensing current flows between said top lead and said bottom lead.

6. The magnetic sensor of claim 5, wherein said capping layer comprises Cu.

7. The magnetic sensor of claim 1, further comprising at least one multilayer that comprises:
a second CoFeOx sublayer below said first CoFe layer; and
a third CoFe sublayer between said second CoFeOx layer and said first CoFeOx layer.

8. The magnetic sensor of claim 1, wherein a percent of oxidation of at least one of said first CoFeOx layer is less than about 10 percent.

9. The magnetic sensor of claim 1, wherein the percentage of Fe with respect to Co is one of 100, 50, 30, 20 and 10 percent in at least one of said first CoFeOx layer, said first CoFe layer and said second CoFe layer.

10. The magnetic sensor of claim 1, wherein oxygen comprises about 2 percent of the total gas pressure in said first CoFeOx layer.

11. The magnetic sensor of claim 1, further comprising a stabilizer including a side shield and a means for biasing said magnetic sensor.

12. The magnetic sensor of claim 1, wherein said pinned layer is one of synthetic and a single layer.

13. The magnetic sensor of claim 1, wherein said spin valve is one of a top type, a bottom type, and a dual type, and said pinned layer is one of (a) single-layered and (b) multi-layered with a spacer between sublayers thereof.

14. The magnetic sensor of claim 1, wherein said spacer is one of:
(a) an insulator for use in a tunnel magnetoresistive (TMR) spin valve;
(b) a conductor for use in a giant magnetoresistive (GMR) spin valve; and
(c) an insulator with a magnetic nano-sized connected between said pinned layer and said free layer for use in a ballistic magnetoresistive (BMR) spin valve.

15. The magnetic sensor of claim 1, wherein said recording medium generates said flux in a magnetic direction that is one of (a) perpendicular and (b) parallel to a plane of said recording medium.

16. The magnetic sensor of claim 1, further comprising:
at least one multi-layer structure, each layer of said multi-layer structure including a first Cu layer positioned adjacent an intermediate layer that includes CoFe.

17. The magnetic sensor of claim 16, wherein said intermediate layer comprises a third CoFe layer.

18. The magnetic sensor of claim 17, wherein X equals 1, corresponding to 2% of oxygen in total gas amount and an MR ratio of said magnetic sensor is greater than about 11% when a thickness of said first CoFe layer facing said spacer is about 9 angstroms, a thickness of said first CoFeOx layer is about 2 angstroms, a thickness of said third CoFe layer is about 9 angstroms, a thickness of said first Cu layer is about 2 angstroms, and a thickness of said second CoFe layer is about 10 angstroms.

19. The magnetic sensor of claim 16, wherein said intermediate layer comprises a second CoFeOx layer sandwiched between a third CoFe layer and a fourth CoFe layer.
